(19) United States
(12) Patent Application Publication
(10) Pub. No.: US 2016/0364798 A1
(43) Pub. Date: Dec. 15, 2016

(54) MARKET IMPACT ANALYSIS TOOL

(71) Applicant: TRADING TECHNOLOGIES INTERNATIONAL INC., Chicago, IL (US)

(72) Inventor: Patrick Joseph ROONEY, St. Charles, IL (US)

(21) Appl. No.: 14/735,833

(22) Filed: Jun. 10, 2015

(51) Int. Cl. G06Q 40/04

(52) U.S. Cl. CPC G06Q 40/04

(57) ABSTRACT

A trading device may analyze proposed trade orders related to tradable objects offered at an exchange and determine the effects of the proposed orders on a market if the proposed orders were matched at the exchange. The trading device may monitor one or more leaned on prices and/or quantities related to the tradable object offered at the exchange. The trading device may notify one or more users that the proposed order may affect one or more leaned on prices and/or quantities that may be relied on by one or more other orders or trading strategies. The trading device may modify or cancel proposed orders or trading strategies to avoid undesired effects in the market.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

An order may be entered or otherwise generated at a trading device to then be submitted to an exchange. When an order is submitted to the trading device, trading software at the trading device may check the conditions associated with the order, such as price and quantity, and prioritize the order with other orders of the same price. The trading device may receive orders that are held at the trading device that are not actively in an exchange. Orders may also be submitted to the exchange as held orders. Orders held at the trading device or at the exchange have the potential to affect the trading at the market.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy, which may be employed with certain disclosed embodiments.

FIG. 5 illustrates inside market information associated with a first tradable object A that can be used to imply prices and quantities in a strategy market.

FIG. 6 illustrates inside market information associated with a first tradable object B that can be used to imply prices and quantities in a strategy market.

FIG. 7 illustrates inside market information associated with a first tradable object AB that can be used to imply prices and quantities in a strategy market.

FIG. 8 illustrates a block diagram of an example electronic trading system in which certain embodiments may be employed.

FIG. 9 illustrates an example method for determining and displaying projected market data.

FIG. 10 illustrates an example method for modifying and/or submitting proposed orders to an exchange.

FIG. 11 illustrates an example display for providing projected market data.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Electronic trading provides a user such as, for example, a trader, a broker and/or an automated trading strategy the technology and opportunity to interact with markets at one or more electronic exchanges. An extension of electronic trading further provides a user the opportunity to conduct an impact analysis of a proposed trade order on a market prior to submitting the order to an exchange to be filled. The results of the impact analysis may allow a user or trading device to determine whether the proposed order, or an order affected by the proposed order, should go forward, be canceled, or be modified.

A trading device may implement and/or execute a trading application configured to conduct an impact analysis on a proposed order before submission to a market and/or exchange. As used herein, a proposed order is an order that is in a held state. Proposed orders may be held at a trading device or in an order book at an exchange. Orders in a held state are not actively being traded in the market. Trading applications implemented at the trading device, such as an order impact manager, may project the proposed order into the market to determine the effect of the proposed order on the market and other orders in the market. The proposed orders may affect implied price levels that may be leaned on by one or more trading strategies or orders generated according to the trading strategies. Implied prices may have a waterfall effect, in which an order in a single contract can change the price of subsequent orders and contracts. By projecting proposed orders into the market, trading devices may project how the market may react if the proposed order were submitted. By determining the effect on the market if a proposed order were submitted, a trading device may preemptively identify to a user how the proposed order may affect the market and decide how to process a proposed order based on the market effect.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Systems, methods, and apparatus are described herein for analyzing the impact of a proposed order on a market, a trading strategy, or one or more orders generated according to the trading strategy. As described herein, an order impact manager may receive market data related to a tradable object offered at an exchange. The market data related to the tradable object offered at the exchange may include prices associated with inside market, a last traded price, a last traded quantity, a best bid price, a best bid quantity, a best order price, or a best order quantity. The market data may be calculated over a period of time. The market data may include a cumulative batch of data for a period of time.

The order impact manager may analyze the orders in an order book at an exchange. The order book may comprise one or more proposed orders related to the tradable object offered at the exchange. A proposed order may comprise an order that is held at a trading device that is not active at the exchange or an order submitted at the exchange as a held order that is unable to be actively matched. The order impact manager may monitor one or more leaned on orders related to the tradable object offered at the exchange. The one or more leaned on orders may be associated with one or more price levels. A leaned on order may include a quantity of such an order at a price level. The order impact manager may apply the at least one proposed order to the received market data. The order impact manager may determine implied impact analysis information based on the received market data and the at least one proposed order. The order impact manager may combine the determined implied impact analysis information with the received market data to determine projected market data. The order impact manager may determine the affected leaned on price levels, for example, based on the determined projected market data. The order impact manager may compare the monitored leaned on orders to the affected leaned on price levels to determine affected leaned on orders.

The order impact manager may generate a display indicating the affected leaned on orders. The affected leaned on orders may include implied orders. The order impact manager may generate a display including the projected market data related to the tradable object. The projected market data may identify the affected orders and/or a projected status of the market if one or more orders are matched at the exchange.

The order impact manager may determine an order submission state for the one or more proposed orders. The order submission state may indicate that the one or more proposed orders will trade, will trade through an order book, will partially trade, will be held, or will be canceled. The order impact manager may communicate the order submission state to a user. The order impact manager may submit an order to an exchange.

The order impact manager may determine whether to modify a proposed order. If the proposed order is modified, the order impact manager may determine how to modify the proposed order. The order impact manager may then submit the modified proposed order. The modified proposed order may be submitted to the order book at the exchange.

The order impact manager may be an implied order manager configured to manage an impact of an implied order on a trading strategy.

The order impact manager may be located at a trading device. The trading device may be a trading terminal and/or a trading server. The order impact manager may be executed, from memory, by a processor at a computing device.

### II. Example Electronic Trading System

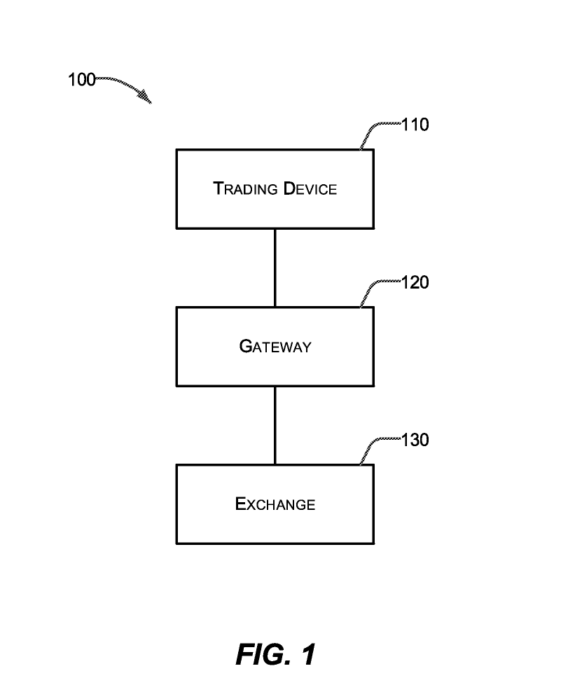

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradable objects to the exchange 130.

Market data may include data about a market for a tradable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradable object is anything which may be traded. For example, a certain quantity of the tradable object may be bought or sold for a particular price. A tradable object may include, for example, financial products, stocks, options, bonds, future contracts, currency, warrants, funds derivatives, securities, commodities, swaps, interest rate products, index-based products, traded events, goods, or a combination thereof. A tradable object may include a product listed and/or administered by an exchange, a product defined by the user, a combination of real or synthetic products, or a combination thereof. There may be a synthetic tradable object that corresponds and/or is similar to a real tradable object.

An order message is a message that includes a trade order. A trade order may be, for example, a command to place an order to buy or sell a tradable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradable objects, for example, offered for trading by the exchange, to be bought and sold. The exchange 130 may include separate entities, some of which list and/or administer tradable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradable objects. Unmatched trade orders may be listed for trading by the exchange 130. Once an order to buy or sell a tradable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

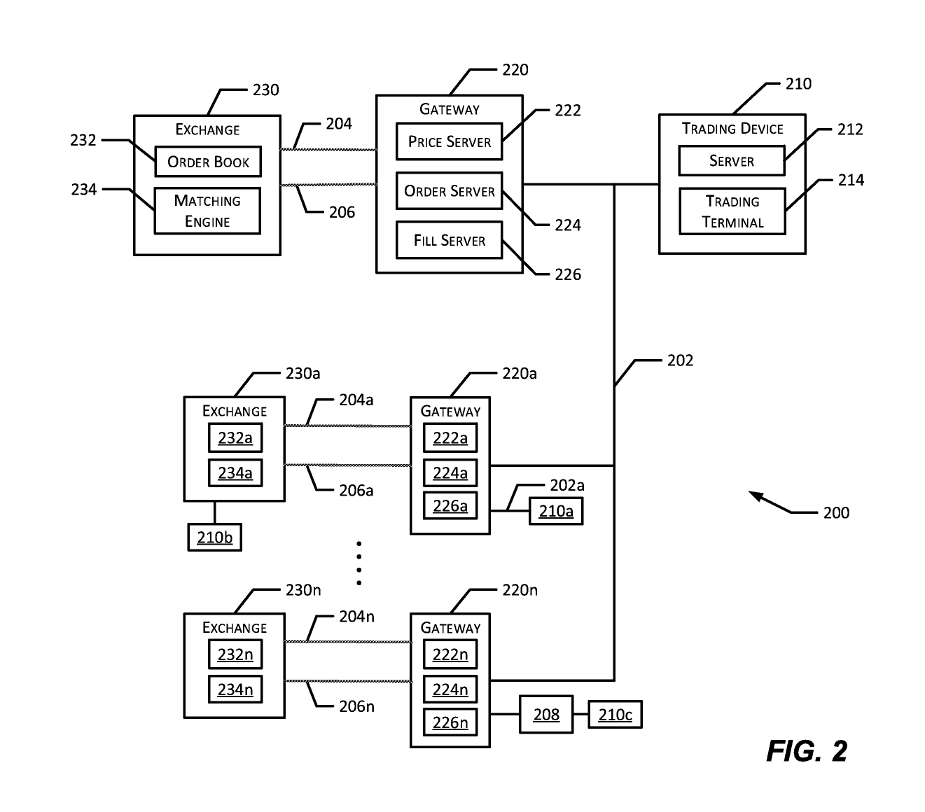

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

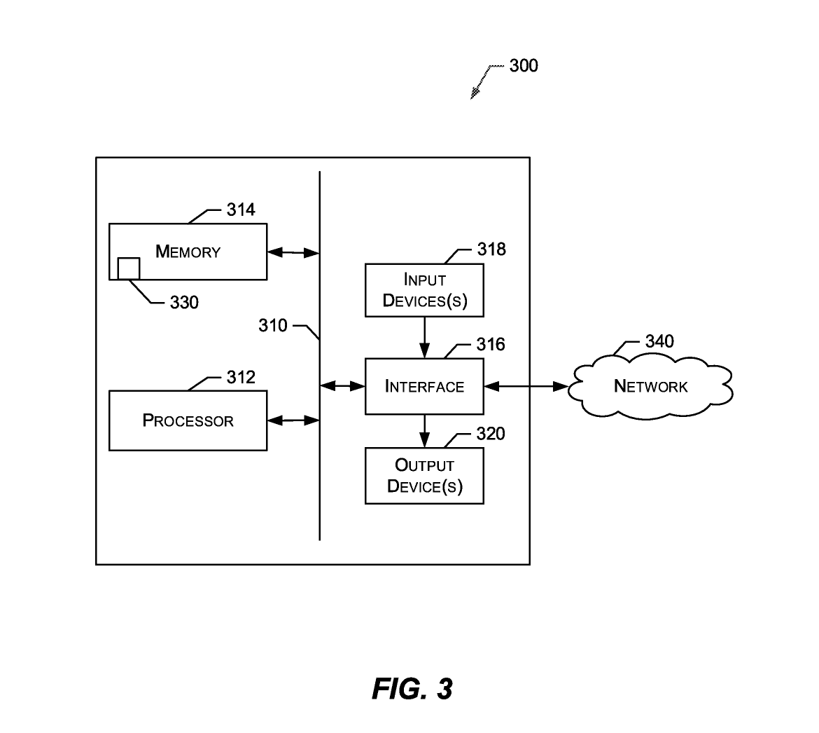

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradable object, a user may trade more than one tradable object according to a trading strategy. One common trading strategy is a spread and trading according to a trading strategy may also be referred to as spread trading. Spread trading may attempt to capitalize on changes or movements in the relationships between the tradable object in the trading strategy, for example.

An automated trading tool may be utilized to trade according to a trading strategy, for example. For example, the automated trading tool may include AUTOSPREADER®, provided by Trading Technologies.

A trading strategy defines a relationship between two or more tradable objects to be traded. Each tradable object being traded as part of a trading strategy may be referred to as a leg or outright market of the trading strategy.

When the trading strategy is to be bought, the definition for the trading strategy specifies which tradable object corresponding to each leg should be bought or sold. Similarly, when the trading strategy is to be sold, the definition specifies which tradable objects corresponding to each leg should be bought or sold. For example, a trading strategy may be defined such that buying the trading strategy involves buying one unit of a first tradable object for leg A and selling one unit of a second tradable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradable object for leg A and selling 3 units of a second tradable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

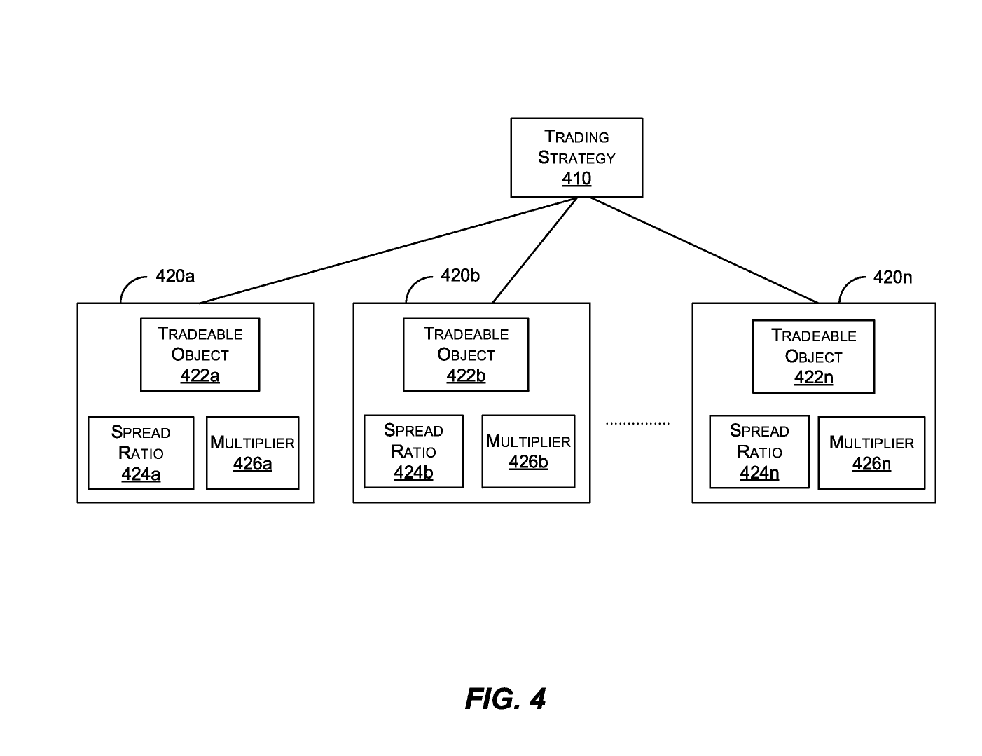

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradable objects 422 (individually identified as tradable object 422a to tradable object 422n) of each of the legs 420a to 420n using the corresponding spread ratios 424a to 424n and multipliers 426a to 426n.

Once defined, the tradable objects 422 in the trading strategy 410 may then be traded together according to the defined relationship. For example, assume that the trading strategy 410 is a spread with two legs, leg 420a and leg 420b. Leg 420a is for tradable object 422a and leg 420b is for tradable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradable object 422a is bought (positive spread ratio, same direction as the spread) and 1 unit of tradable object 422b is sold (negative spread ratio, opposite direction of the spread). As mentioned above, typically in spread trading the opposite of the definition applies. That is, when the definition for the spread is such that when the spread is sold, 1 unit of tradable object 422a is sold (positive spread ratio, same direction as the spread) and 1 unit of tradable object 422b is bought (negative spread ratio, opposite direction of the spread).

The price for the trading strategy 410 is determined based on the definition. In particular, the price for the trading strategy 410 is typically the sum of price the legs 420a-420n comprising the tradable objects 422a-422n multiplied by corresponding multipliers 426a-426n. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradable product. In contrast, a synthetic spread may not be listed as a product at an exchange, but rather the various legs of the spread are tradable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradable object 422a typically has a price 10 greater than tradable object 422b, then it may be advantageous to buy the spread whenever the difference in price between tradable objects 422a and 422b is less than 10 and sell the spread whenever the difference is greater than 10. As an example, assume that tradable object 422a is at a price of 45 and tradable object 422b is at a price of 40. The current spread price may then be determined to be (1)(45)+(−1)(40)=5, which is less than the typical spread of 10. Thus, a user may buy 1 unit of the spread, which results in buying 1 unit of tradable object 422a at a price of 45 and selling 1 unit of tradable object 422b at 40. At some later time, the typical price difference may be restored and the price of tradable object 422a is 42 and the price of tradable object 422b is 32. At this point, the price of the spread is now 10. If the user sells 1 unit of the spread to close out the user's position (that is, sells 1 unit of tradable object 422a and buys 1 unit of tradable object 422b), the user has made a profit on the total transaction. In particular, while the user bought tradable object 422a at a price of 45 and sold at 42, losing 3, the user sold tradable object 422b at a price of 40 and bought at 32, for a profit of 8. Thus, the user made 5 on the buying and selling of the spread.

The above example assumes that there is sufficient liquidity and stability that the tradable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, and/or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Implied Price

In an example, implied quantities and implied prices may be calculated based on information associated with direct orders in a combination of outright markets that imply orders into a spread market, also commonly referred to as “implied in” orders. For example, using three tradable objects A, B, and C, the tradable objects A, B, C can imply orders into three spread markets. Specifically, an example tradable object AB may be a first spread strategy having the tradable object A as a first leg and the tradable object B as a second leg. An example tradable object AC may be a second spread strategy having the tradable object A as a first leg and the tradable object C as a second leg. Finally, an example tradable object BC may be a third spread strategy having the tradable object B as a first leg and the tradable object C as a second leg.

When an exchange (e.g., the example exchange 130 of FIG. 1 and/or the example exchange 230 of FIG. 2) provides a spread, the exchange may provide a relationship between two or more tradable objects that form the spread. For example, the following relationships may be used for the spreads AB, AC and BC described above:

Spread AB=Leg A−Leg B EQN (1)

Spread AC=Leg A−Leg C EQN (2)

Spread BC=Leg B−Leg C EQN (3)

Further, each equation above may be used to generate two separate equations, one for buying and one for selling a spread. For example, using the first spread equation (EQN (1)), the following buy and sell definitions may be derived:

Buy AB=Buy A−Sell B EQN (4)

Sell AB=Sell A−Buy B EQN (5)

The relationships in EQNs. (4) and (5) may then be used to calculate bid (buy) and ask (sell) implied quantities and prices.

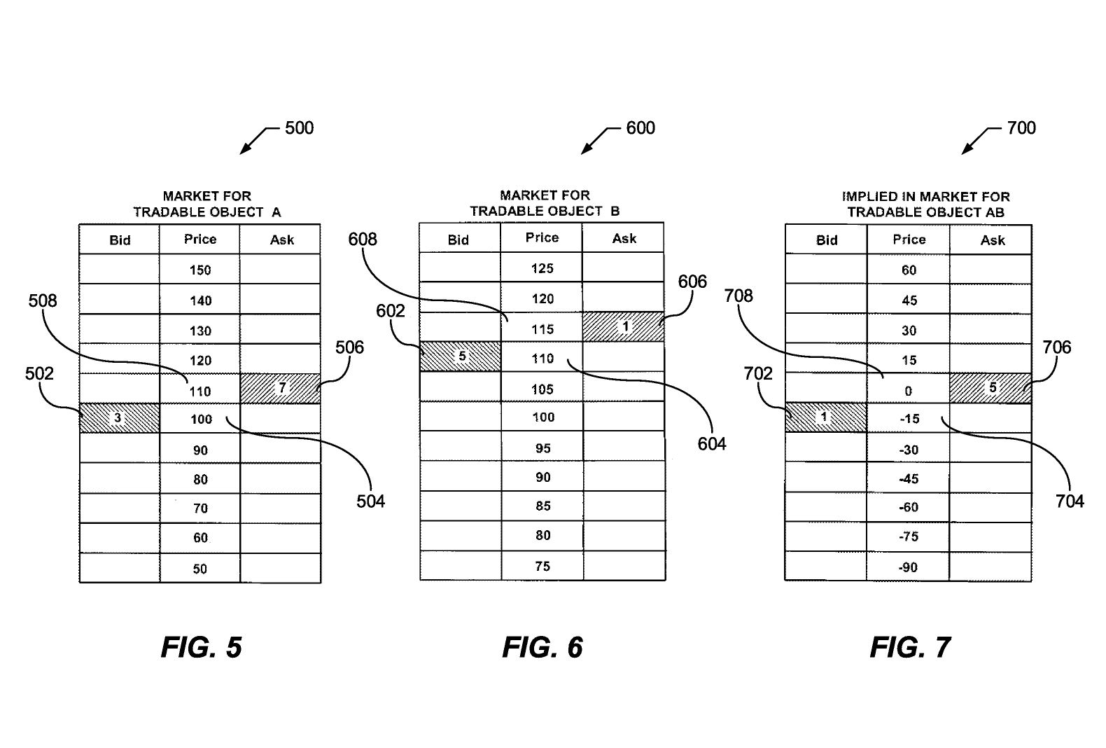

FIG. 5 illustrates an example graphical user interface 500 displaying inside market information associated with a first tradable object A being traded on a first exchange. As described above, the inside market represents the highest buy price and the lowest sell price. As illustrated in the graphical user interface 500, there is an example bid quantity 502 of three (3) at an example bid price 504 of 100 (e.g., 100 dollars), and there is an example ask quantity 506 of seven (7) at an example ask price 508 of 110 (e.g., 110 dollars). In the illustrated example of FIG. 5, bid orders and ask orders are assumed to be direct, meaning that the orders were placed directly on the market associated with the first tradable object A.

FIG. 6 illustrates an example graphical user interface 600 displaying inside market information associated with a second tradable object B. As illustrated in the graphical user interface 600, there is an example bid quantity 602 of five (5) at an example bid price 604 of 110 (e.g., 110 dollars), and there is an example ask quantity 606 of one (1) at an example ask price 608 of 115 (e.g., 115 dollars). Also, similarly to FIG. 5, in the illustrated example of FIG. 6, orders associated with the tradable object B are assumed to be direct orders (e.g., placed directly into a market associated with the second tradable object B).

The orders associated with the first tradable object A and the second tradable object B can imply orders into a spread tradable object AB. FIG. 7 illustrates an example graphical user interface 700 displaying implied prices and implied quantities for a spread AB having the tradable object A as a first leg and the tradable object B as a second leg. The implied prices for the spread AB can be calculated using EQNs. (4) and (5) above. As illustrated in the graphical user interface 700, there is an example implied bid quantity 702 of one (1) at an example implied bid price 704 of minus fifteen (−15), and there is an example implied ask quantity 706 of five (5) at an example implied ask price 708 of zero (0).

It should be understood that if quantities at price levels other than the inside market are available, implied prices and implied quantities for the spread AB may be calculated for quantities at those price levels as well. For example, using EQN. (4), the price to buy the spread AB may be found by subtracting the example ask price 608 (e.g., 115) from the example buy price 502 (e.g., 100) (e.g., 100-115), which is the example implied bid price 704 (e.g., −15). In this example, the quantity at the implied bid price 704 (e.g., −15) is the minimum of the bid quantity 502 (3) and the ask quantity 606 (1), which is the example implied bid quantity 702 (1). It should be understood that the minimum of the quantities is used because once a quantity associated with the second leg is used (e.g., used up), there is no quantity left to match the quantity remaining in the first leg (e.g., two (2)).

Similarly, using EQN (5), a price to sell the spread AB may be found by subtracting the example bid price 604 (e.g., 110) from the example ask price 508 (110) (e.g., 110-110), which is the example implied ask price 708 (e.g., zero (0)). In this example, the implied ask quantity 706 is five (5) based on the minimum of the ask quantity 506 (e.g., 7) and the bid quantity 602 (e.g., 5) associated with the two legs of the spread AB. Referring to FIG. 7, the computed implied quantities and prices are shown for the spread AB.

In certain embodiments, tradable objects are expressed in a vector notation. For example, it may be desirable to express a market associated with each tradable object as an identity vector, such that the tradable object A may be represented by the vector (1, 0, 0), the tradable object B may be represented by the vector (0, 1, 0), and the spread of tradable objects AB may be represented by the vector (0, 0, 1). In some such embodiments, each vector is of the same size, where the size of the vector corresponds to the number of tradable objects in the set. In this example, there are three tradable objects so that each vector has three dimensions. Also, strategy markets with two or more legs can be also expressed as a definition vector. For example, buying spread AB can be also defined using the vector (1, −1, 0), which means buying one quantity of the tradable object A and selling one quantity of the tradable object B. In such an embodiment, selling the spread AB can be defined using the vector (−1, 1, 0), which represents selling one quantify of the tradable object A and buying one quantity of the tradable object B.

Additional and/or different implied calculations may be performed, such as those described in commonly-owned U.S. Pat. No. 7,765,134, issued on Jul. 27, 2010 and entitled “System and Method for Determining Implied Market Information,” and commonly-owned U.S. Pat. No. 8,019,673, issued on Sep. 13, 2011 and entitled “Implied Matrix for Tradeable Objects,” the contents of each of which are incorporated by reference herein in their entirety.

### VII. Order Impact Analysis

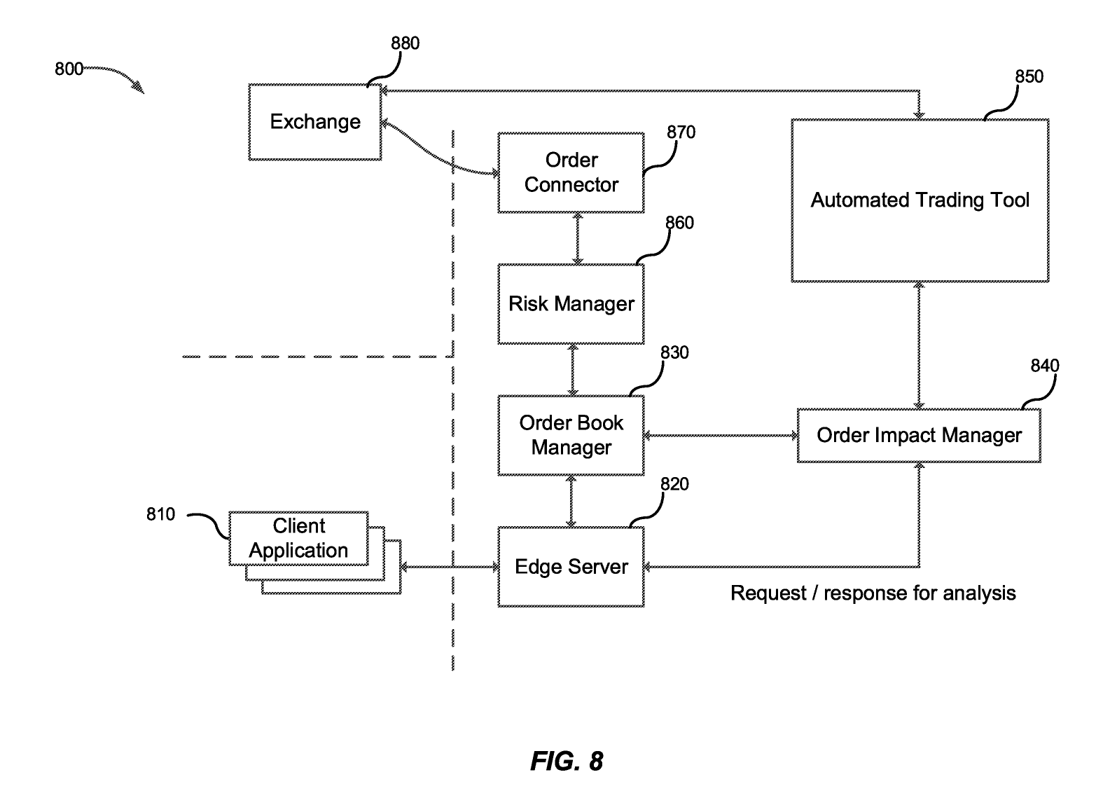

FIG. 8 illustrates a block diagram of an example electronic trading system 800 in which certain embodiments may be employed. As shown in FIG. 8, the system 800 may include one or more client applications, such as the client application 810, which may be a trading application, or a portion of a trading application, on a trading device or another computing device. The client application 810 may provide an interface for a user, such as a user submitting a trade order or a user defining a trading strategy, for example. The client application 810 may be operable to communicate with other entities in the system 800. For example, a user may input parameters for trade orders or other commands into the client application 810 and may send order messages including the trade orders for submitting a trade order to an exchange 880 via the client application 810.

The order messages may be received and/or processed by one or more other entities in the system 800 prior to being submitted to the exchange 880. For example, the system 800 may include an order impact manager 840, an edge server 820, an order book manager 830, a risk manager 860, and/or an order connector 870 that may receive order messages, or trade orders therein, and may process the trade orders prior to trade orders being submitted to the exchange 880.

The client application 810 may be in communication with the edge server 820. The client application 810 may send order messages or other instructions to the edge server 820. The edge server 820 may be a web server that resides on a trading device, such as a trading server, and may communicate with the client application 810. The edge server 820 may be a gateway such as the gateway 220 shown in FIG. 2. The trading device on which the edge server 820 resides may be the same trading device or a different trading device from the trading device on which the client application 810 resides. For example, the client application 810 may be executed on a trading terminal such as the trading terminal 214 shown in FIG. 2, while the edge server 820 may reside on a trading server such as the trading server 212 shown in FIG. 2.

The edge server 820 may receive order messages or other instructions from one or more client applications, such as the client application 810. The order messages may include a trade order to buy or sell one or more tradable objects at the exchange 880. The trade orders may be proposed orders. Proposed orders are orders that are in a held state at a trading device and are not active or otherwise available to be traded at an exchange. Proposed orders also include orders that are submitted to the trading device as held orders for being held at an exchange. A proposed order may include instructions regarding the buying and/or selling of one or more tradable objects. The proposed orders may lean on factors in the market or exchange 880, such as other orders, contracts, bids, or prices levels. A trade order may be, for example, a command to place an order to buy or sell a tradable object; a command to initiate managing orders according to a defined trading strategy; a command to change, modify, or cancel an order; an instruction to an electronic exchange relating to an order; or a combination thereof.

The edge server 820 may be in communication with the order book manager 830 and/or the order impact manager 840 for communicating the trade orders or other instructions received from the client application 810 and communicating information received from the order book manager 830 and/or the order impact manager 840 to the client application 810. The edge server 820 may send the proposed trade orders in the order messages received from the client application 810 to the order book manager 830. The edge server 820 may accumulate a batch of proposed trade orders for being submitted to the order book manager 830. The order book manager 830 may include orders received from the edge server 820 and client application 810, such as proposed orders, as well as orders working in the market, such as the exchange 880 and/or other exchanges. The order book manager 830 may submit proposed orders to an order book at the exchange 880 and manage orders that are pending in the order book.

The risk manager 860 may communicate with the order book manager 830. The risk manager 860 may receive orders from the order book manager 830 and may provide the order book manager 830 with risk information for the trade orders. The order book manager 830 may manage the trade orders based on the risk information. The risk manager 860 may send the orders to the order connector 870. The order connector 870 may communicate the orders to the exchange 880. The order connector 870 may communicate with the exchange 880 to receive market data from the exchange 880 and may send the received market data back to the order book manager 830 via the risk manager 860 for managing the order book at the exchange 880. For example, the order connector may receive information from the exchange 880 that an order is filled.

As shown in FIG. 8, the order book manager 830 may be in communication with the order impact manager 840. The order impact manager 840 may have a complete picture of current market conditions at a given time. The order book manager 830 may send the proposed orders and/or market data from the exchange 880 to the order impact manager 840 to determine the impact of one or more orders, on a market, other orders, and/or trading strategies. The order impact manager 840 may also, or alternatively, receive the market data from the exchange 880 via an automated trading tool 850. The market data may be received from the automated trading tool 850 and/or exchange 880 in market update messages or order update messages that indicate the updated market data at the exchange 880.

The automated trading tool 850 may calculate one or more parameters for a trade order according to a trading strategy based on the market data and automatically send the order message to an exchange, such as the exchange 880. The trade order generated at the automated trading tool 850 may be a pending order or an order ready to be matched at the exchange 880. The trade order generated at the automated trading tool 850 may be an order to buy a tradable object, an order to sell the tradable objects, a spread order, and/or an implied order, for example. The automated trading tool 850 may communicate trade orders to the order impact manager 840 for processing by the order impact manager 840 and/or the order book manager 830 prior to being submitted to an exchange, such as the exchange 880. The automated trading tool 850 may communicate trade orders to the exchange 880 on an alternative communication link that may avoid such processing.

The order impact manager 840 may receive information about current trading strategies from the automated trading tool 850. The order impact manager 840 may receive information from the automated trading tool 850 continuously, periodically, or the order impact manager 840 may request information from the automated trading tool 850. The information about the current trading strategies may include trade order information that may be generated by the automated trading tool 850 for trading strategies, such as order price levels and/or quantities at the exchange 880 that are leaned on for a leg of a trading strategy. The leaned on order price levels may include implied order price levels at the exchange 880 or order price levels that may be leaned on for the implied price levels of an implied market on which a trading strategy may rely. The leaned on order price levels may be price levels within a predefined range of an order price. The leaned on order price levels may be price levels with a predefined order quantity.

The order impact manager 840 may analyze the market data and the proposed orders to generate order impact analysis information. The order impact manager 840 may analyze the market data and the proposed orders in response to a request from the client application 810 or the order book manager 830, at pre-defined periods of time, and/or in response to receiving one or more proposed orders. The order impact analysis information may include the market data, or portions thereof, that reflect a state of the market (e.g., order prices and/or quantities) if one or more proposed orders are filled at the exchange 880. The order impact analysis information may be used to analyze the impact of one or more proposed orders on trading strategies or trade orders generated by the automated trading tool 850 according to trading strategies. The order impact analysis information may be implied impact analysis information that may be used to analyze the impact of one or more proposed orders on trading strategies that may be trading on an implied market.

The order impact manager 840 may combine the order impact analysis information with the received market data to determine the differences, if any, between the market data in the order impact analysis information and the originally received market data. For example, the order impact manager 840 may compare the determined order impact analysis information with the received market data from the exchange 880 to highlight the differences in the market data at the exchange 880 and a market in which the proposed order is filled. The comparison may reveal the price levels that may no longer be leaned on in the exchange 880 or may no longer be available at the exchange 880 if the proposed orders are filled, because the quantity of the leaned on price level is no longer available (e.g., zero or less than the quantity needed to match a trade order generated according to a trading strategy).

The order impact manager 840 may compare the price levels that may no longer be leaned on in the exchange 880 or may no longer be available at the exchange 880 with the information about current trading strategies from the automated trading tool 850, such as leaned on order price levels and/or quantities for the trading strategies, to determine the affected leaned on orders or leaned on prices in a market. The order impact manager 840 may send a message, via the client application 810, to the user that submitted the proposed order that the proposed order affects one or more leaned on orders or leaned on prices. The order impact manager 840 may display the affected leaned on orders and/or leaned on prices to the user via the client application 810. The order impact manager 840 may also indicate to the user that defined the affected trading strategy that one or more leaned on orders or leaned on prices may be affected by a proposed order.

The order impact manager 840 may determine projected market data based on the price levels that may no longer be leaned on in the exchange 880 or may no longer be available at the exchange 880 and may display the projected market data to a user via the client application 810. The projected market data may identify affected trading strategies, affected leaned on orders and/or leaned on prices, affected orders that are leaning on a price level and/or quantity, or a combination thereof based on a proposed order. The projected market data may also, or alternatively, reflect changes in the received market data based on the proposed order. For example, the projected market data may include changes to an inside market, a market depth, a last traded price, a last traded quantity, or a combination thereof. The projected market data may include changes in implied prices and/or implied quantities at an implied market if one or more proposed orders were filled at the exchange 880. For example, the order impact manager 840 may determine a change in the implied bid price, implied bid quantity, implied ask price, implied ask quantity, or combination thereof that may result from matching the proposed orders at the exchange 880. The change in the implied prices and/or implied quantities may result from projecting a fill of a proposed order at the exchange 880.

The order impact manager 840 may identify, to the order book manager 830, the proposed orders that affect a currently pending trading strategy, trading strategies associated with one or more predefined users, a threshold number of trading strategies (e.g., more than 3), or a combination thereof. The order book manager 830 may flag the proposed orders that affect a trading strategy and/or the orders that are pending in an order book according to the trading strategy. The flagged proposed orders may be sent to the client application 810 from which the proposed order was received and/or the client applications associated with trading strategies affected by the proposed orders. The client application 810 may identify to a user the proposed orders that affect a trading strategy and/or the affected trading strategies. The client application 810 may provide options to the user for modifying or canceling the proposed order to avoid affecting the trading strategy.

The order impact manager 840 may determine an order submission state for a proposed order. When the proposed order is initially submitted to the order book manager 830, the order book manager 830 may put the proposed order in the proposed order state. The order impact manager 840 may send an updated order submission state to the order book manager 830 and the order book manager may update the order submission state for the proposed order and process the proposed order according to the updated order submission state. The order submission state may be sent to the client application 810 (e.g., from the order book manager 830 or the order impact manager 840) for being displayed to a user. The order submission state may include a trade state that indicates to trade the proposed order, an order book trade state that indicates to trade the proposed order through the order book, a partial trade state that indicates to partially trade the proposed order, a hold or held state that indicates to hold the proposed order at the exchange 880, or a prevent trade state that indicates to prevent the proposed order from being traded at the exchange 880 (e.g., delete the order from the order queue).

The order impact manager 840 may determine whether to trade a proposed order or whether to partially trade the proposed order based on whether the proposed order affects a current trading strategy. If the proposed order does not affect a currently pending trading strategy, trading strategies associated with one or more predefined users, a threshold number of trading strategies (e.g., more than 3), or a combination thereof, the order submission state may be set to the trade state or the order book trade state and the proposed order may be traded. If the proposed order does affect a currently pending trading strategy, trading strategies associated with one or more predefined users, a threshold number of trading strategies (e.g., more than 3), or a combination thereof, the order submission state may be set to the prevent trade state and the proposed order may be canceled. The order impact manager 840 may set the order submission state to the prevent trade state to cancel the proposed order if the order quantity of a leaned on price would be unavailable if the proposed order were matched or if the proposed order otherwise affects a trading strategy, trading strategies associated with one or more predefined users, a threshold number of trading strategies (e.g., more than 3), or a combination thereof. The order impact manager 840 may set the order submission state to the hold or held state to hold the proposed order if the order quantity of a leaned on price would be unavailable if the proposed order were matched or if the proposed order otherwise affects a trading strategy, trading strategies associated with one or more predefined users, a threshold number of trading strategies (e.g., more than 3), or a combination thereof. The order impact manager 840 may change the order submission state from the hold state to the trade state or the order book trade state when the order quantity of a leaned on price becomes available at the exchange 880.

The order impact manager 840 may determine that the proposed order would not affect a trading strategy, or would cause less harm to a trading strategy, if the order quantity of the proposed order were reduced by an amount. If the order impact manager 840 decides to reduce the amount of the proposed order, then the order impact manager 840 may set the order submission state to the partial trade state. The order impact manager 840 may determine the reduced order quantity for the proposed trade and may send the reduced order quantity to the order book manager 830 for modifying the proposed order to include the reduced quantity. The proposed order may be reduced by an amount equal to a leaned on order quantity, a multiple of the leaned on order quantity, or the leaned on order quantity and a lean base for a trading strategy that is leaning on the same price of the tradable object as the proposed order.

The reduced order quantity may be sent from the order impact manager 840 or the order book manager 830 to the client application 810. The client application 810 may notify the user of the reduced order quantity for the proposed order and/or prompt the user to accept the reduced quantity. If the user accepts the reduced quantity for the proposed order, the client application may send an indication that the user accepts the reduced order quantity to the order book manager 830 and/or the order impact manager 840 and the proposed order may be modified and/or submitted to the exchange 880. If the user declines the reduced quantity for the proposed order, the client application may send an indication that the user declines the reduced order quantity to the order book manager 830 and/or the order impact manager 840 and the proposed order may be canceled and/or deleted from the order queue by the order book manager 830.

The order impact manager 840 may set the order submission state of a proposed order based on a level of priority associated with the proposed order or a user that submitted the proposed order or defined the trading strategy affected by the proposed order. For example, a user that submitted an order that is held at an exchange may have a higher priority than a user that submitted a proposed order, so the order impact manager may change the order state of the proposed order to the prevent order state and cancel the proposed order.

The level of priority may be based on the order quantity and/or the fees that may be incurred by filling proposed orders or other orders that may be submitted according to a trading strategy. For example, previously submitted orders that have a higher order quantity may be given a higher level of priority than a proposed order having a lower quantity, as the orders having the higher quantity may produce more fees at the exchange.

The user may input instructions regarding the state of the proposed order into the client application 810. For example, the user may send an instruction to the order book manager 830, via the client application 810, to cancel the order, modify the order, hold the order, or trade the order. If the instructions are to cancel the order, the order book manager 830 may delete the order from a queue at the order book manager 830 and/or the order book at the exchange 880. If the instructions are to modify the order, the order book manager 830 may submit the modified order to the exchange 880 or send the modified order to the order impact manager 840 for analysis. If the instructions are to trade the order, the order book manager 830 may send the order to the exchange 880 for being matched. If the instructions are to hold the order, the order book manager 830 may submit the proposed order to the exchange 880 as a held order. The client application 810 may send the instructions to the edge server 820, which will then forward the instructions to the order book manager 830.

The instruction from the user may be used to update the order submission state for a proposed order. The instructions to cancel the proposed order may cause the order submission state to transition to the prevent trade state. The instructions to modify the proposed order may cause the order submission state to transition to the partial trade state. The instructions to trade the proposed order may cause the order submission state to transition to the trade state or the order book trade state. The instructions to hold the proposed order may cause the order submission state to transition to the hold order state. The order may be held at the exchange 880 until the order book manager 830 identifies that the proposed order quantity is available at the exchange 880 in addition to the leaned on order quantity for a trading strategy.

The order impact manager 840 may notify different users that a trade order from the automated trading tool 850 will not trade or may partially trade if a proposed order is filled. For example, the order impact manager 840 may notify the user that submitted the proposed order, via the user's client application 810, that the proposed order may affect a trading strategy or that a subsequent order will not trade or may partially trade if the proposed order is matched. The user may input instructions into the client application 810 to modify the proposed order, cancel the proposed order, or attempt to trade the proposed order.

The order impact manager 840 may notify the user that defined the affected trading strategy, via the user's client application 810, that the trading strategy is affected and/or that a trade order generated in accordance with the trading strategy may not trade or may partially trade. The user may input instructions into the client application 810 to modify the trading strategy, cancel the trading strategy, modify an order generated according to the trading strategy that is affected by the proposed order, cancel the order affected by the proposed order, or attempt to trade the order affected by the proposed order.

The entities in the system 800 may be included in hardware and/or software. The client application 810 may reside on the same or a different computing device than other entities in the system 800. For example, the client application 810 may reside on a trading terminal and the order impact manager 840, the edge server 820, the order book manager 830, the automated trading tool 850, the risk manager 860, the order connector 870, or a combination thereof may reside on a trading server or an exchange, such as the exchange 880. In another example, the order impact manager 840, the edge server 820, the order book manager 830, the automated trading tool 850, the risk manager 860, the order connector 870, or a combination thereof may reside on the same computing device as the client application 810. Each entity in the trading system 800 may reside on a single device or be distributed across multiple devices.

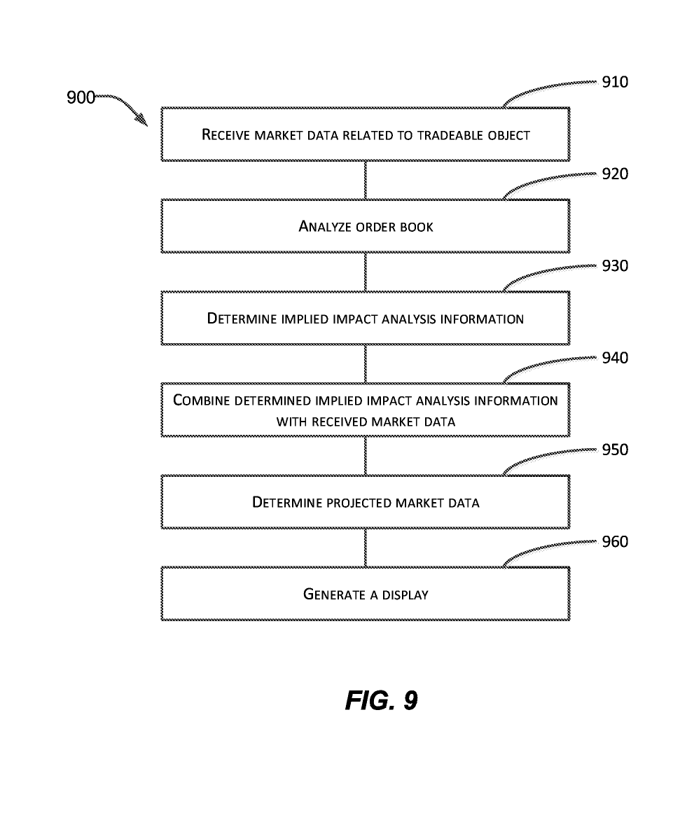

FIG. 9 illustrates an example method for projecting an implied price based on proposed orders. The method 900, or portions thereof, may be performed by one or more computing devices, such as a trading device or another computing device. In an example, the method 900, or portions thereof, may be performed by an order impact manager residing at one or more computing devices.

At 910, market data related to a tradable object is received. For example, an order impact manager may receive market data from an exchange and/or an automated trading tool. The order impact manager may be an implied order manager configured to manage an impact of a proposed order on an implied market. The received market data related to the tradable object may include prices associated with an inside market (e.g., a best bid price and/or a best ask price), a market depth (e.g., a best bid quantity and/or a best ask quantity), a last traded price, a last traded quantity, or a combination thereof. The market data related to the tradable object may be calculated over a period of time. The market data may include cumulative batch data for a period of time.

At 920, an order book may be analyzed. For example, an order impact manager may analyze an order book to determine whether one or more proposed orders are resting in the order book. A proposed order may be an order that is held at a trading device that is not active at the exchange or an order submitted at the exchange as a held order that is unable to be actively matched. The proposed order may include an order price and order quantity related to the tradable object offered at the exchange.

If a proposed order is resting in an order book, at 930, an order impact analysis may be generated based on the proposed order. For example, an order impact manager may determine implied impact analysis information that may be used to analyze the impact of one or more proposed orders on trading strategies that may be trading on an implied market comprising two or more legs related to tradable objects at different exchanges. The implied impact analysis information may be determined by projecting the proposed order into the market of a leg of the trading strategy and generating a picture of the market if the proposed order were filled.

At 940, the determined implied impact analysis information may be combined with the received market data. For example, an order impact manager may compare the determined implied impact analysis information with the received market data. This comparison may highlight the differences, if any, in the market in which the proposed order is not filled and a market in which the proposed order is filled. The comparison may reveal the price levels that may no longer be leaned on or may no longer be available if the proposed order is filled.

At 950, projected market data may be determined. For example, an order impact manager may determine the projected market data. The projected market data may be determined based on the comparison from 940. The projected market data may include market data from the market if the proposed order is filled. For example, the projected market data may include the bid price, the bid quantity, the ask price, the ask quantity, or combination thereof that may be changed in a market as a result of the matching of the proposed order. The projected market data may indicate the bid price, the bid quantity, the ask price, the ask quantity, or combination thereof that result from matching the proposed order.

The project market data may also, or alternatively, include implied market data (e.g., implied bid price, implied bid quantity, implied ask price, implied ask quantity, or combination thereof) for an implied market that leans on the order price of the proposed order. The projected market data may include the implied market data (e.g., implied bid price, implied bid quantity, implied ask price, implied ask quantity, or combination thereof) that results from the proposed order being matched for at least one leg of a trading strategy. For example, the proposed order may cause a leaned on price level to be unavailable for a trading strategy and may cause a bid price to increase or an ask price to decrease due to the quantity value of the proposed order being unavailable.

At 960, a display may be generated. For example, an order impact manager may generate a display that includes the proposed trade orders that affect one or more trading strategies, the affected trading strategies, the affected leaned on price levels and/or quantities, and/or the projected market data determined at 950.

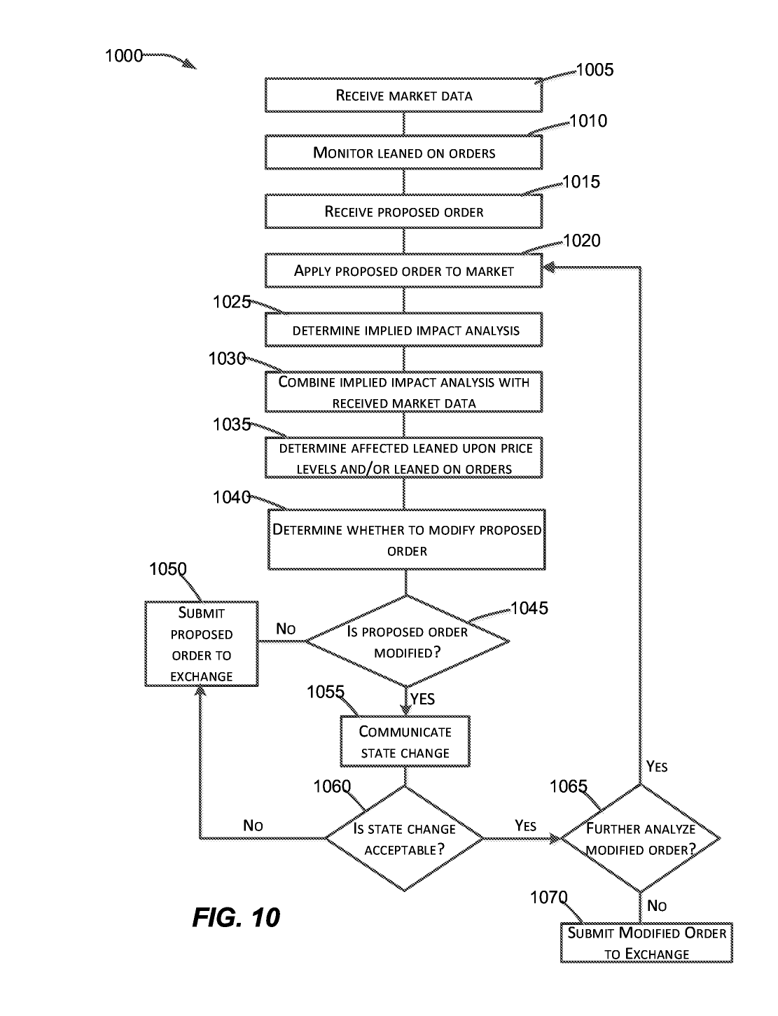

FIG. 10 illustrates another example method for projecting implied prices from proposed orders. The method 1000, or portions thereof, may be performed by one or more computing devices, such as a trading device or another computing device. In an example, the method 1000, or portions thereof, may be performed by an order impact manager residing at one or more computing devices.

At 1005, market data related to a tradable object is received. For example, an order impact manager may receive market data from an automated trade tool and/or an exchange. The order impact manager may be an implied order manager configured to manage an impact of a proposed order on an implied market. The received market data related to the tradable object may include prices associated with an inside market (e.g., a best bid price and/or a best ask price), a market depth (e.g., a best bid quantity and/or a best ask quantity), a last traded price, a last traded quantity, or a combination thereof. The market data related to the tradable object may be calculated over a period of time. The market data may include cumulative batch data for a period of time.

At 1010, leaned on orders may be monitored. For example, an order impact manager may monitor leaned on orders associated with active trading strategies, spreads and other synthetic products. Orders in an order book or in an exchange may be monitored to determine orders and/or price levels that are leaned on. The leaned on orders and/or price levels may be monitored to provide a picture of which tradable objects are available in the market.

At 1015, a proposed order may be received. A proposed order may be sent by a client application. A proposed order may be received by an order book and/or by an order impact manager. A proposed order may be an order that is held at a trading device that is not active at the exchange or an order submitted at the exchange as a held order that is unable to be actively matched. The proposed order may be related to the tradable object offered at the exchange. The trade price of the proposed order may be the same trade price being leaned on by a leg of a trading strategy trading on an implied market. At 1020, the proposed order may be applied to the market. For example, an order impact manager may apply the proposed order to the market. The proposed order being applied to the market may simulate the proposed order being filled in the market and/or at the exchange.

At 1025, implied impact analysis information may be determined. For example, an order impact manager may determine the implied impact analysis information. At 1030, the determined implied impact analysis information may be combined with the received market data. For example, an order impact manager may compare the determined implied impact analysis information with the received market data. This comparison may highlight the differences, if any, in the market in which the proposed order is not filled and a market in which the proposed order is filled.

At 1035, the affected leaned on price levels and/or leaned on orders may be determined. For example, the order impact manager may determine the affected leaned on price levels and/or leaned on orders. Based on the comparison at 1030, the price levels that may no longer be leaned on or may no longer be available if the proposed order is filled may be determined. The affected leaned on price levels and/or leaned on orders may impact other orders or trading strategies that may rely on the leaned on price levels and/or leaned on orders. The other orders or orders that may be generated according to the current trading strategies may not be filled if the proposed order is filled. As a result, the proposed order may be modified, canceled, held, or approved without modification before submission to the exchange.

At 1040, a determination may be made whether to modify the proposed order. If the proposed order affects leaned on price levels and/or leaned on orders, it may be determined that the proposed order will not trade or will partially trade. If the proposed order affects leaned on price levels and/or leaned on orders, the proposed order may be modified in order to be submitted to and/or traded in the exchange without affecting the leaned on price levels and/or leaned on orders. The proposed order may be also be canceled or held if the proposed order affects leaned on price levels and/or leaned on orders.

The order impact manager may determine whether to modify the proposed order at 1040. The order impact manager may determine how the proposed order may be modified in order to trade at the exchange. For example, it may be determined that the proposed order will not trade as originally proposed, but will trade at a different order price or order quantity. The order price may be changed to the next lowest bid price or the next highest ask price to avoid a leaned upon price. The order quantity may be changed to preserve an order quantity at the originally proposed order price for the tradable object that is sufficient to match the order quantity being leaned on. If the proposed order does not affect leaned on price levels and/or leaned on orders, the proposed order may be submitted to the exchange without modification.

If the proposed order is determined to be modified, at 1045, the order submission state may be changed and communicated at 1055. The order submission state change may be communicated to an order book manager and/or a client application. The order impact manager may communicate the order submission state change to an edge server, and the edge server may communicate the state change to the client application. The order submission state may be a flag or notification indicating that the proposed order will not trade as originally submitted, will partially trade, or will trade through the order book. The communicated order submission state change may include the determined proposed modification from 1040. If it is determined at 1045 that a proposed order is not modified in order to trade, the proposed order may be submitted to the exchange at 1050 for being traded.

At 1060, a determination of whether the order submission state change is acceptable may be made. The order impact manager may determine whether the order submission state change is acceptable. A user may input into the client application whether the order submission state change is acceptable and the input may be communicated to the order impact manager. If the order submission state change is not acceptable at 1060, the proposed order may be submitted to the exchange at 1050. The proposed order may be accepted or rejected at the exchange. If the order submission state change is determined to be acceptable at 1060, a determination may be made at 1065 as to whether the modified proposed order should be further analyzed before submission to the exchange or whether the modified proposed order may be submitted to the exchange. If the modified proposed order is determined to be further analyzed at 1065, the method 1000 may proceed to 1020 to apply the modified proposed order to the market data. If it is determined that the modified proposed order may proceed to the exchange, the modified proposed order may be submitted to the exchange at 1070.

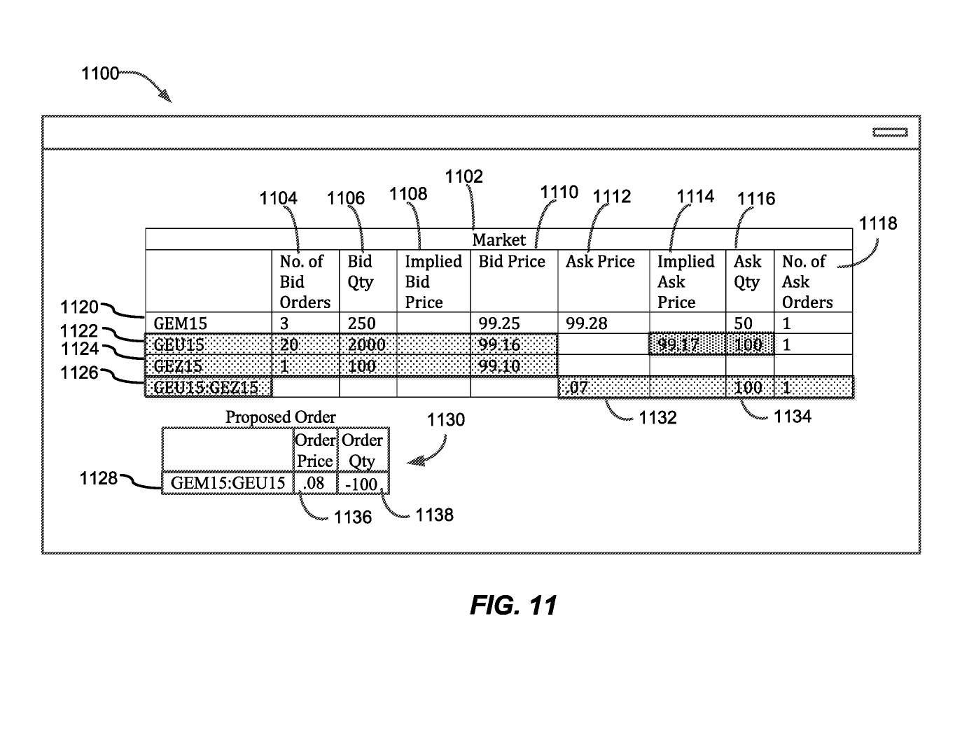

FIG. 11 is an example of a graphical display 1100 that may be provided to a user to identify an example of how a proposed order may affect one or more other orders in a market. The graphical display 1100 may be generated at one or more computing devices. For example, the graphical display 1100 may be generated by one or more entities in the system 800 (e.g., the order impact manager 840 and/or the client application 810) for being displayed at the client application 810 on a computing device.

As shown in FIG. 11, display 1100 includes market data 1102 for tradable objects 1120, 1122, and 1124 offered at one or more exchanges. The tradable objects 1120, 1122, and 1124 in the present example represent futures contracts. The market data 1102 includes a number of held bid orders 1104 and a number of held ask orders 1118 for the tradable objects 1120, 1122, and 1124. The market data 1102 includes a bid quantity 1106 for the held bid orders 1104 and an ask quantity 1116 for the held ask orders 1118. The market data 1102 includes a bid price 1110 for the held bid orders 1104 and an ask price 1112 for the held ask orders 1118.

The display 1100 includes the implied bid price 1108 and the implied ask price 1114 that may be used to indicate implied prices that may be determined based on the legs of a spread order. The display 1100 identifies a spread 1126 from which orders in the market data 1102 are generated. The spread 1126 is a synthetic spread having tradable object 1122 as a leg and the tradable object 1124 as another leg. The spread 1126 includes a spread price 1132 and a spread quantity 1134. The spread 1126 includes the bid order 1104 for the tradable object 1124 and the ask order 1118 for the tradable object 1122. The ask order 1118 for the tradable object 1124 has an implied ask price 1114 that is calculated by adding the spread price 1132 to the bid price 1110 of the bid order 1104 for the tradable object 1124.

The display 1100 may identify a proposed order 1130. The proposed order 1130 may be an order submitted via a client application at a trading device and may be submitted in the proposed order state. As shown in the display 1100, the proposed order 1130 is an implied order or a spread order that includes a spread 1128 having tradable object 1120 as a leg and tradable object 1122 as another leg. The proposed order 1136 has a spread price 1136 and an order quantity 1138. Though the proposed order is an implied or spread order in FIG. 11, the proposed order may be another type of order, such as an individual bid order or ask order.

The proposed order 1130 may be submitted to an order impact manager for determining whether the proposed order 1130 affects any of the held orders being identified in the market data 1102. The order impact manager may determine that the proposed order 1130 may cause an order to be submitted to the exchange that would affect a currently held order by matching a leaned on order or price. As shown in FIG. 11, the order impact manager may determine that the proposed order 1130 may cause an ask order to be submitted at an implied bid price of 99.17 which matches and/or corresponds to the implied ask price 1114 of 99.17 associated with the tradable object 1122. The order quantity for the proposed order 1130 is the same as the ask quantity 1116 for the tradable object 1122 and may cause the ask quantity 1116 for the tradable object 1122 to be completely matched at the implied ask price 1114, leaving the implied ask price 1114 as being unavailable.

The order impact manager may determine the bid orders 1104 that may be leaning on the implied ask price 1114 or the bid price 1110 that may be affected by the proposed order 1130 if the proposed order 1130 is submitted to the exchange for being matched. The order impact manager may determine that the bid orders 1104 for the tradable object 1122 are leaning on the implied ask price 1114 for the tradable object 1122, as the implied ask price 1114 may be within a predefined price of the bid orders 1104 for the tradable object 1122 and/or the ask quantity 1116 for the tradable object may meet a predefined threshold. As the bid orders 1104 for the tradable object 1122 may be leaning on the implied ask price 1114 for the tradable object 1122, the order impact manager may identify the bid orders 1104 for the tradable object 1122 as being affected by the proposed order 1130. The bid orders 1104 for the tradable object 1122 may be identified in the projected market data generated at the order impact manager and the identified bid orders 1104 may be displayed to a user. As shown in FIG. 11, the bid orders 1104 for the tradable object 1122 may be highlighted or otherwise identified. The corresponding bid quantity 1106 and/or bid price 1110 for the tradable object 1122 may be identified as being affected by the proposed order 1130. The tradable object 1122 itself may also be identified as being affected by the proposed order 1130.

The implied ask price 1114 and/or the corresponding ask quantity 1116 for the tradable object 1122 may be included in the projected market data and may be identified as being affected by the proposed order 1130. The implied ask price 1114 and/or the corresponding ask quantity 1116 may be identified differently than the other orders that may be affected by the implied ask price 1114 being unavailable (e.g., orders leaning on the implied ask price 1114).

The order impact manager may determine that the order for the spread 1126 may be affected, as the implied ask price 1114 on which the spread 1126 is based may no longer be available if the proposed order 1130 is filled. The order 1118 for the spread 1126 may be highlighted or otherwise identified. The corresponding bid quantity 1134 and/or the spread price 1132 for the spread 1126 may be identified as being affected by the proposed order 1130. The spread 1126 itself may also be identified as being affected by the proposed order 1130.

The order impact manager may determine that the bid order 1104 for the tradable object 1124 may be affected by the proposed order 1130, as the bid order 1104 for the tradable object 1124 is a part of the spread 1126 that may be affected. Accordingly, the bid order 1104 for the tradable object 1124 may be highlighted or otherwise identified. The corresponding bid quantity 1106 and/or bid price 1110 for the tradable object 1124 may be identified as being affected by the proposed order 1130. The tradable object 1124 itself may also be identified as being affected by the proposed order 1130.

The proposed order 1130 and the orders that may be affected by the proposed order 1130 being filled may be compared and may be processed based on a level of priority. The level of priority may be associated with the user that submitted the order. For example, the user that submitted the proposed order 1130 may have a higher level of priority than the users that submitted the orders 1104 for the tradable object 1122, so the order impact manager may allow the proposed order 1130 to proceed to the exchange for being matched.

The level of priority may be based on the order quantity and/or the fees that may be incurred by filling the orders. For example, the held orders 1104 for the tradable object 1122 may be given a higher level of priority than the proposed order 1130, because the bid quantity 1106 is higher than the order quantity 1138 for the proposed order 1130 and may produce more fees at the exchange. The order impact manager may modify or cancel the proposed order 1130, automatically or according to user input, to avoid affecting other orders. The orders that may be affected may also, or alternatively, be canceled, automatically or according to user input, in an attempt to avoid being affected by the proposed order 1130.

Though not shown in the display 1100, the display 1100 may include projected market data that identifies the market data if the proposed order 1130 were matched. The projected market data may reflect the implied ask price 1114 of the tradable object 1122 being matched and/or the bid price 1110 of the tradable object 1120 being matched. The projected market data may also reflect the orders for the tradable object 1122, the tradable object 1124, and/or the spread 1126 as being canceled, withdrawn, or modified as a result of the proposed order 1130.

Though the proposed order 1130 is a single order in FIG. 11, a batch of multiple orders may be entered at the display 1100 and may be submitted to the order impact manager for analysis. The batch of orders may be analyzed at the same time by the order impact manager. The display 1100 may provide the projected market data that is generated based on the batch of orders.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, by an order impact manager, market data related to a tradable object offered at an exchange;
analyzing, by the order impact manager, an order book comprising at least one proposed order related to the tradable object offered at the exchange;
determining, by the order impact manager, implied impact analysis information based on the received market data and the at least one proposed order;
combining, by the order impact manager, the determined implied impact analysis information with the received market data to determine projected market data; and
generating, by the order impact manager, a display including the projected market data related to the tradable object.

2. The method of claim 1, wherein the order impact manager is an implied order manager configured to manage an impact of an implied order on a trading strategy.

3. The method of claim 1, wherein the market data related to the tradable object offered at the exchange comprises at least one of the following: a last traded price, a last traded quantity, a best bid price, a best bid quantity, a best order price, or a best order quantity.

4. The method of claim 1, wherein the market data related to the tradable object offered at the exchange is calculated over a period of time.

5. The method of claim 1, wherein the market data related to the tradable object offered at the exchange comprises a cumulative batch of data for a period of time.

6. The method of claim 1, wherein the at least one proposed order comprises at least one order that is held at a trading device that is not active at the exchange or at least one order submitted at the exchange as a held order that is unable to be actively matched.

7. The method of claim 1, wherein the order impact manager is located at a trading device.

8. The method of claim 7, wherein the trading device comprises a trading terminal.

9. The method of claim 7, wherein the trading device comprises a trading server.

10. The method of claim 1, wherein the order impact manager is executed, from memory, by a processor at a computing device.

11. A method comprising:
receiving, by an order impact manager, market data related to a tradable object offered at an exchange;
analyzing, by the order impact manager, an order book comprising at least one proposed order related to the tradable object offered at the exchange;
monitoring, by the order impact manager, one or more leaned on orders related to the tradable object offered at the exchange, wherein the one or more leaned on orders are associated with one or more price levels;
applying, by the order impact manager, the at least one proposed order to the received market data;
determining, by the order impact manager, implied impact analysis information based on the received market data and the at least one proposed order;
combining, by the order impact manager, the determined implied impact analysis information with the received market data to determine projected market data;
determining, by the order impact manager, affected leaned on price levels based on the determined projected market data;
comparing, by the order impact manager, the monitored leaned on orders to the affected leaned on price levels to determine affected leaned on orders; and
generating, by the order impact manager, a display indicating the affected leaned on orders.

12. The method of claim 11, wherein the method further comprises determining, by the order impact manager, an order submission state for the at least one proposed order.

13. The method of claim 12, wherein the method further comprises communicating, by the order impact manager, the order submission state of the at least one proposed orders to a user.

14. The method of claim 13, wherein the order submission state indicates that the at least one proposed order will trade, the at least one proposed order will trade through the order book, the at least one proposed order will partially trade, or the at least one proposed order will not trade.

15. The method of claim 11, wherein the method further comprises generating, by the order impact manager, a display including the projected market data related to the tradable object.

16. The method of claim 11, wherein the method further comprises determining, by the order impact manager, whether to modify the at least one proposed order.

17. The method of claim 16, further comprising:
if the at least one proposed order is modified, determining, by the order impact manager, a modified proposed order;
submitting, by the order impact manager, the modified proposed order to the exchange; and
communicating, by the order impact manager, an order submission state of the modified proposed order to a user.

18. The method of claim 16, further comprising, if the one or more proposed orders are not modified, submitting, by the order impact manager, the proposed order to the exchange.

19. The method of claim 11, wherein the order impact manager is located at a trading device.

20. The method of claim 11, wherein the order impact manager is executed, from memory, by a processor at a trading device.
